(19) United States
(12) Patent Application Publication
(10) Pub. No.: US 2014/0058841 A1
(43) Pub. Date: Feb. 27, 2014

(54) METHOD AND SYSTEM FOR PROVIDING INTENT-BASED PROXIMITY MARKETING

(71) Applicant: Jeffrey Mark Getchius, Cambridge, MA (US)

(72) Inventor: Jeffrey Mark Getchius, Cambridge, MA (US)

(73) Assignee: Verizon Patent and Licensing Inc., Basking Ridge, NJ (US)

(21) Appl. No.: 13/590,219

(22) Filed: Aug. 21, 2012

(51) Int. Cl. G06Q 30/02

(52) U.S. Cl. 705/14.58

(57) ABSTRACT

An approach for providing intent-based proximity marketing is described. A user is detected to be within proximity of a location. Purchase intent information of the user is determined in response to the detection. The purchase intent information is associated with the location.

### BACKGROUND INFORMATION

Service providers are continually challenged to deliver value and convenience to consumers by providing compelling network services and advancing the underlying technologies. For example, in recent years, service providers have utilized context information to provide users with more relevant advertisements, recommendations, or other promotions. For instance, electronic billboards and digital signs may be programmed to dynamically change their presentation based on the current time to better reflect the interest of consumers who pass by. Nonetheless, such an approach relies heavily on generalities about consumers as a whole, for instance, with respect to the current time, which may not provide adequate targeting to particular individuals or consumer groups.

Therefore, there is a need for an approach to more effectively market to individual consumers and/or consumer groups.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing intent-based proximity marketing, according to an embodiment;

FIG. 2 is a diagram of the components of an intent-based marketing platform, according to an embodiment;

FIG. 3 is a flowchart of a process for providing intent-based proximity marketing using meta-models, according to an embodiment;

FIG. 4 is a flowchart of a process for presenting program information at a location based on purchase intent information, according to an embodiment;

FIG. 5 is a flowchart of a process for updating purchase intent information, according to an embodiment;

FIG. 6 is a flowchart of a process for generating offers based on purchase intent information and customer information, according to an embodiment;

FIGS. 7A-7F are diagrams of scenarios with intent-based proximity marketing, according to various embodiments;

FIG. 8 is a diagram of a computer system that can be used to implement various embodiments; and

FIG. 9 is a diagram of a chip set that can be used to implement an embodiment of the invention.

### DESCRIPTION OF THE PREFERRED EMBODIMENT

An apparatus, method, and software for providing intent-based proximity marketing are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

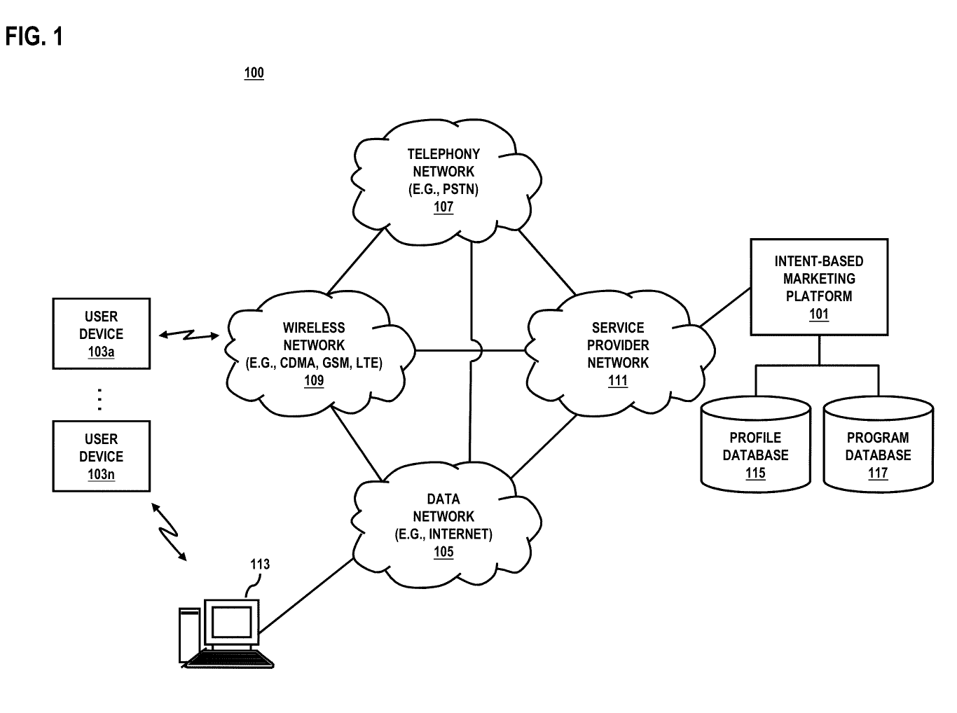

FIG. 1 is a diagram of a system capable of providing intent-based proximity marketing, according to an embodiment. For the purpose of illustration, the system 100 employs an intent-based marketing platform 101 that is configured to facilitate proximity marketing using intent information. One or more user devices 103 (or user devices 103a-103n) may, for instance, be utilized to access services related to proximity marketing over one or more networks (e.g., data network 105, telephony network 107, wireless network 109, service provider network 111, etc.). According to one embodiment, these services may be included as part of managed services supplied by a service provider (e.g., a wireless communication company) as a hosted or a subscription-based service made available to users of the user devices 103 through the service provider network 111. Such service includes tracking of users' intention to conduct transactions as a factor in encouraging loyalty to a particular product or service offered, for example, by retailers. In this regard, intent-based marketing platform 101 may determine a user's propensity to purchase or otherwise obtain the product/service.

As shown, the intent-based marketing platform 101 may be a part of or connected to the service provider network 111. According to another embodiment, the intent-based marketing platform 101 may be included within or connected to the user devices 103, a computing device 113, etc. In certain embodiments, the intent-based marketing platform 101 may include or have access to a profile database 115 and a program database 117. For example, the intent-based marketing platform 101 may generate or update purchase intent information of a user based on the purchase-related actions by the user and/or other purchase-related actions by other users and/or groups associated with the user. Thereafter, the purchase intent information may be associated with the user and stored in the profile database 115. In addition, the program database 117 may be utilized to store advertisements and other media from service and content providers along with scheduling information and other program information generated based on the purchase intent information. While specific reference will be made thereto, it is contemplated that the system 100 may embody many forms and include multiple and/or alternative components and facilities. Intent-based marketing platform 101, in some embodiments, can effectively provide targeted proximity marketing, for instance, by generating presentation of promotional content based on purchase intent information of consumers detected within proximity of electronic marketing devices (e.g., via their respective micro-locations).

As mentioned, service providers have utilized dynamic advertising for electronic billboards and digital signs on the streets, in tunnels, in buildings, etc., to better target consumers who pass by such billboards and signs. For example, billboards and signs may be programmed to dynamically change their presentation based on the current time to better reflect the interest of consumers who pass by (e.g., breakfast-related content in the morning, lunch-related content around noon, and dinner-related content in the evening). Nonetheless, these typical approaches rely heavily on generalities about consumers as a whole, for instance, with respect to the current time (e.g., all consumers want breakfast in the morning, lunch around noon, and dinner in the evening). As indicated, reliance on such generalities fail to target the individual or particular consumer groups, and, thus, these typical approaches may not offer effective marketing.

To address this issue, the system 100 of FIG. 1 provides the capability to provide intent-based proximity marketing. Specifically, the intent-based marketing platform 101 may detect that a user is within proximity of a location. Then, in response to the detection, the intent-based marketing platform 101 may determine purchase intent information of the user, and associate the purchase intent information with the location. In one scenario, the intent-based marketing platform 101 may determine that a potential customer is physically close to a digital sign (e.g., based on proximity sensors on the digital sign, a global positioning system (GPS) module on the customer's mobile device, etc.) and that the customer is currently walking towards the digital sign. As such, the purchase intent information of the customer is determined and associated with the micro-location of the digital sign. The purchase intent information may, for instance, be based on purchase-related actions initiated in the past by the customer, other users associated with the customer, a group associated with the customer, etc. As an example, it may be determined that the customer has scanned several price tags for Item X at various stores, but that the customer has not purchased Item X from any of those stores. In addition, it may be determined that the customer has purchased other items similar to Item X at prices less than the previously scanned prices for Item X. Therefore, the customer's purchase intent information may indicate that the customer “intends” or at least has some interest in acquiring Item X at a price less than the previously scanned prices. If, for instance, the digital sign is located near a store that is willing to sell Item X for a certain price less than the previously scanned prices, an advertisement for Item X at the certain price may be generated for rendering on the digital sign when the customer passes by.

Thus, in another embodiment, the intent-based marketing platform 101 may generate program information for the location based on the association of the purchase intent information with the location. The intent-based marketing platform 101 may then render a presentation at the location based on the program information. By way of example, the program information may relate to a schedule, an advertisement, the user, or a combination thereof. Accordingly, in one scenario, the program information may include scheduling information for a digital sign that indicates the promotional content to present to the user and the time that the content should be presented (e.g., based on items that the user intends to purchase, the prices that the user intends to purchase the items for, the time that the user is likely to pass by the digital sign, etc.). Accordingly, in this way, the purchase intent information may be utilized to provide the user with customized programs (e.g., advertisements with personalized prices).

Other factors that may used to generate the program information may, for instance, include sign location, time of day, and environmental cues (e.g., consumers around the digital sign). For example, in another scenario, the intent-based marketing platform 101 may provide ad-hoc scheduling of advertisements at various electronic displays in a number of different micro-locations in a particular shopping area using environmental cues, such as movement detection, faces perceived, identity information transmitted from mobile devices, object recognition (e.g., purchases, jewelry, etc.), style of clothing, height of detected users, smoking by users, gesture recognition (e.g., hand gestures, facial expressions, etc.), or other cues detected around those electronic displays. Therefore, different advertisements may be presented at a particular electronic display based on what is sensed around that electronic display.

Moreover, in some embodiments, the rates that advertisers are charged for presenting their advertisements on the electronic display may vary based on what is sensed around that display (e.g., the number of people around the display, the likelihood of those people to buy the product in the advertisement, etc.). In certain embodiments, group scheduling and collaborative filter may be utilized to overcome issues with respect to accuracy and relevancy (e.g., to put the right content on the electronic display at the right time).

In another embodiment, the intent-based marketing platform 101 may determine a purchase-related action by the user, and then update the purchase intent information based on the purchase-related action. As indicated, in one use case, a user may initiate actions that indicate his/her intent to make a purchase (e.g., scanning a price tag of an item or service, searching for the item or service online, browsing information associated with the item or service, checking out with the item or service in the shopping cart, etc.). Consistent monitoring of these purchase-related actions may, for instance, be performed so that the user's purchase intent information may reflect the user's current purchase intentions.

Additionally, or alternatively, the intent-based marketing platform 101 may determine other purchase-related actions of another user, a group, or a combination thereof associated with the user, and then update the purchase intent information based on the other purchase-related actions. By way of example, collaborative filtering techniques may be used to determine and update the user's purchase intent information by analyzing purchase-related actions of other users and/or groups associated with the user (e.g., other users and/or groups determined to have tastes and preferences similar to those of the user).

In another embodiment, the intent-based marketing platform 101 may determine a value that the user associates with an item within the proximity of the location based on the purchase intent information. The intent-based marketing platform 101 may then generate offer information relating to the item for the user based on the value. Accordingly, in one scenario, automatic bargaining and bidding may occur between users and merchants based on users' purchase intent information. For example, the list price of an item at a nearby store and a user's desired price determined from the purchase intent information may be used to calculate an offer (or an invite to offer) on the item for presentation to the user. In another scenario, users may manually indicate a desired price for an item along with the degree of negotiability of the desired price (e.g., how much more would the users be willing to pay for the item), and the purchase intent information may be based on the manually-indicated desired price. As such, automatic bargaining and bidding may be performed according to the manually-indicated desired price.

In another embodiment, the intent-based marketing platform 101 may determine an identity of the user in response to the detection. The intent-based marketing platform 101 may then determine customer information of the user based on the identity. By way of example, when a customer is detected within proximity of a bank, the bank employees may be presented with the customer's information (e.g., name, photograph, account information, etc.) using the customer's identity information (e.g., name, bank card number, etc.). As a result, the bank employees may make preparations prior to the customer's arrival to expedite and/or enhance the customer's banking experience.

In some embodiments, the customer information may include loyalty information, discount information, or a combination thereof associated with the user. By way of another example, when a customer is detected within proximity of a store, the customer may be presented with a customized coupon (e.g., buy one, get one free) based on the customer's history of loyalty to the store (e.g., frequency visits and purchases at the store). Consequently, the combination of the proximity of the user to the store and the customized loyalty coupon may strongly encourage the customer to shop at the store.

It is noted that the intent-based marketing platform 101, the user devices 103, the computing device 113, and other elements of the system 100 may be configured to communicate via the service provider network 111. According to certain embodiments, one or more networks, such as the data network 105, the telephony network 107, and/or the wireless network 109, may interact with the service provider network 111. The networks 105-111 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 105-111 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that the networks 105-111 may include components and facilities to provide for signaling and/or bearer communications between the various components or facilities of the system 100. In this manner, the networks 105-111 may embody or include portions of a signaling system 7 (SS7) network, Internet protocol multimedia subsystem (IMS), or other suitable infrastructure to support control and signaling functions.

Further, it is noted that the user devices 103 may be any type of mobile or computing terminal including a mobile handset, mobile station, mobile unit, multimedia computer, multimedia tablet, communicator, netbook, Personal Digital Assistants (PDAs), smartphone, media receiver, personal computer, workstation computer, set-top box (STB), digital video recorder (DVR), television, automobile, appliance, etc. It is also contemplated that the user devices 103 may support any type of interface for supporting the presentment or exchange of data. In addition, user devices 103 may facilitate various input means for receiving and generating information, including touch screen capability, keyboard and keypad data entry, voice-based input mechanisms, accelerometer (e.g., shaking the user device 103), and the like. Any known and future implementations of user devices 103 are applicable. It is noted that, in certain embodiments, the user devices 103 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of user devices 103 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 103, i.e., IP addresses that are accessible to devices connected to the service provider network 111 as facilitated via a router.

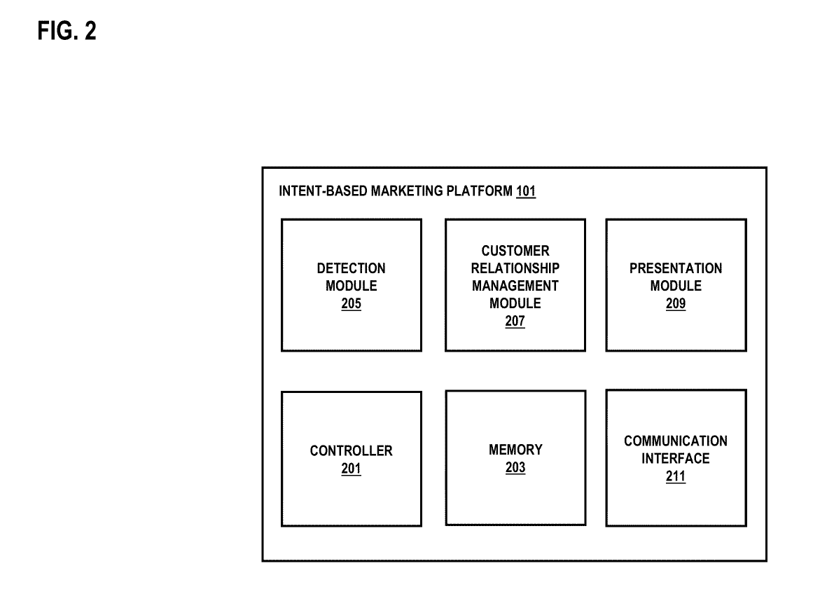

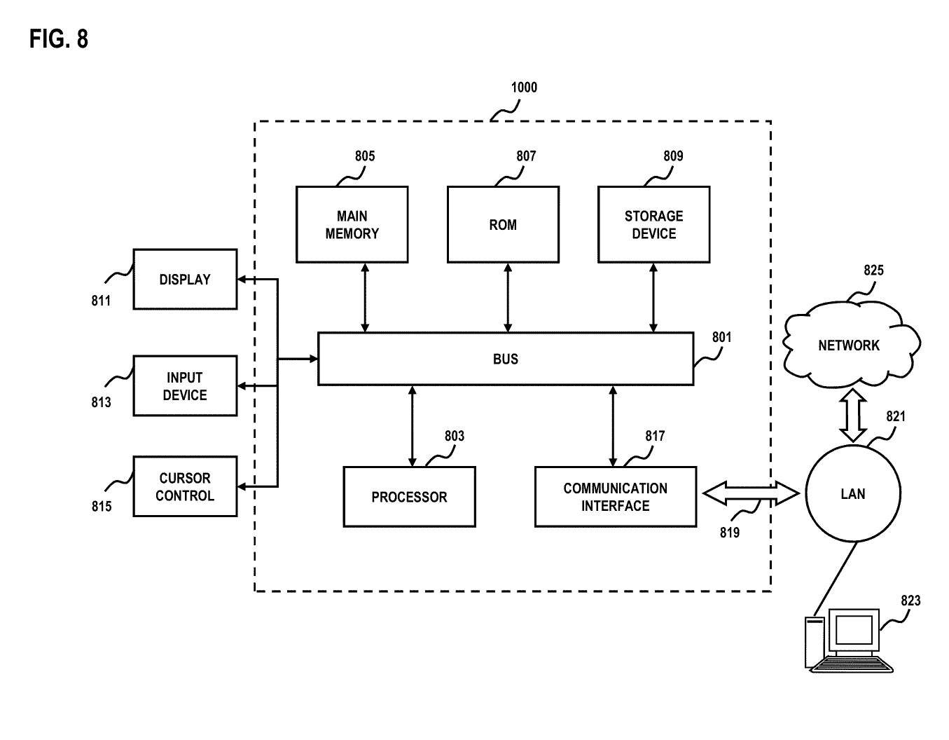

FIG. 2 is a diagram of the components of an intent-based marketing platform, according to an embodiment. The intent-based marketing platform 101 may comprise computing hardware (such as described with respect to FIG. 8), as well as include one or more components configured to execute the processes described herein for providing intent-based proximity marketing. It is contemplated that the functions of these components may be combined in one or more components or performed by other components of equivalent functionality. In certain embodiments, the intent-based marketing platform 101 includes a controller (or processor) 201, memory 203, a detection module 205, a customer relationship management module 207, a presentation module 209, and a communication interface 211.

The controller 201 may execute at least one algorithm for executing functions of the intent-based marketing platform 101. For example, the controller 201 may interact with the detection module 205 to detect whether a user is within proximity of a location. When such detection occurs, the detection module 205 may signal the customer relationship management module 207 with respect to the detected user along with proximity information (e.g., distance, time, etc., from the location). In response, the customer relationship management module 207 may determine purchase intent information of the user (e.g., via the profile database 115), and associate the purchase intent information with the location.

As indicated, in some embodiments, the customer relationship management module may generate program information based on the association (e.g., scheduling information or other content from the purchase intent information of the user, the location, and the media stored at the program database 117). The customer relationship management module 207 may then direct the presentation module 209 to render a presentation at the location based on the program information. As discussed, in certain embodiments, the program information may relate to a schedule, an advertisement, the user, or a combination thereof.

The controller 201 may also work with the customer relationship management module 207 to determine new purchase-related actions of the user as well as other purchase-related actions of other users, groups, etc., associated with the user to update the purchase intent information of the user at the profile database 115. As mentioned, various techniques and approaches may be utilized to determine and update the purchase intent information (e.g., collaborative filtering techniques).

The controller 201 may further utilize the communication interface 211 to communicate with other components of the intent-based marketing platform 101, the user devices 103, and other components of the system 100. The communication interface 211 may include multiple means of communication. For example, the communication interface 211 may be able to communicate over short message service (SMS), multimedia messaging service (MMS), internet protocol, instant messaging, voice sessions (e.g., via a phone network), email, or other types of communication.

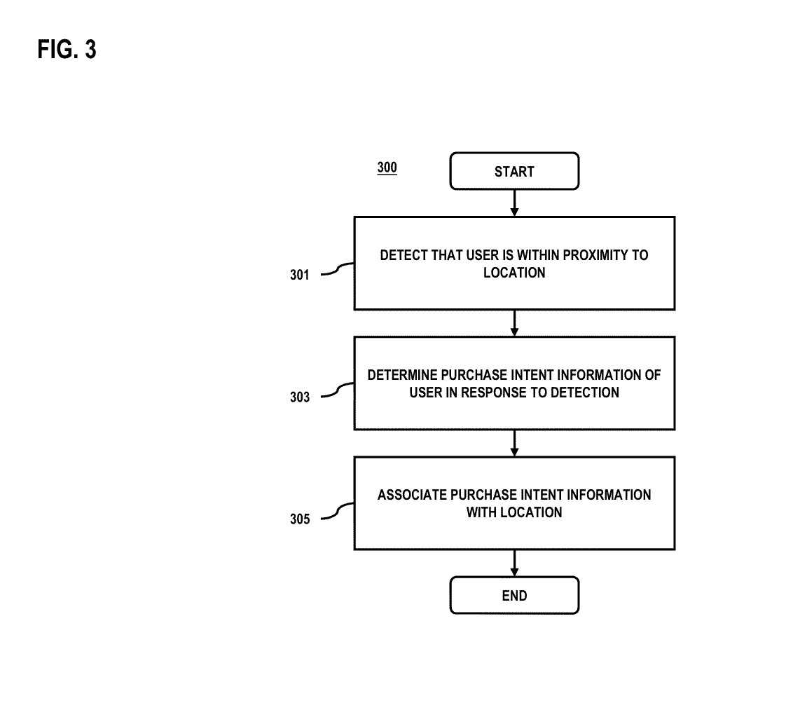

FIG. 3 is a flowchart of a process for providing intent-based proximity marketing, according to an embodiment. For the purpose of illustration, process 300 is described with respect to FIG. 1. It is noted that the steps of the process 300 may be performed in any suitable order, as well as combined or separated in any suitable manner. In step 301, the intent-based marketing platform 101 may detect that a user is within proximity of a location. By way of example, GPS data from the user's mobile device, proximity sensors, etc., may be used to determine the user position with respect to the location. Additionally, or alternatively, the detection may rely on a number of environmental cues sensed by one or more devices at the location. As indicated, these environmental cues may include movement detection, faces perceived, identity information transmitted from mobile devices, object recognition, style of clothing, height of detected users, smoking by users, gesture recognition, etc. In one scenario, for instance, advanced robotics techniques may be used to integrate multiple sources of “belief” of location to determine a user's position. For example, phone readings (e.g., including environmental cues) from the user's mobile device may be processed by a Monte Carlo particle filter to produce a belief distribution indicating that the user is closer to a first digital signal at a first micro-location than a second digital signal at a second micro-location.

In step 303, the intent-based marketing platform 101 may determine purchase intent information of the user in response to the detection. As mentioned, the purchase intent information (e.g., information indicating a user's intent to purchase an item, a service, etc.) may be based on purchase-related actions initiated in the past by the user, other users associated with the user, a group associated with the customer, etc. As used herein, purchase-related actions may refer to actions that are typically associated with purchasing an item or service, such as scanning a price tag of the item or service, searching for the item or service online, browsing information associated with the item or service, checking out with the item or service in the shopping cart, etc. Moreover, in one embodiment, “intent” may be quantified by the number of times the user expresses an interest in a particular item or service—e.g., a purchase-related actions may be defined depending on the item or service, and a threshold can be set to trigger intent if the purchase-related action is performed in an amount to satisfy the threshold. For example, in one use case, sufficient “intent” to purchase a particular item may be shown by a user who has searched for the item on an online search engine, browsed information associated with the item, and scanned a price tag of the item at a physical store. Subsequently, in step 305, the intent-based marketing platform 101 may associate the purchase intent information with the location. In this way, the intent-based marketing platform 101 may effectively provide proximity marketing, for instance, by utilizing the purchase intent information to generate customized content and schedules of the content for presentation to the user on one or more devices at the location.

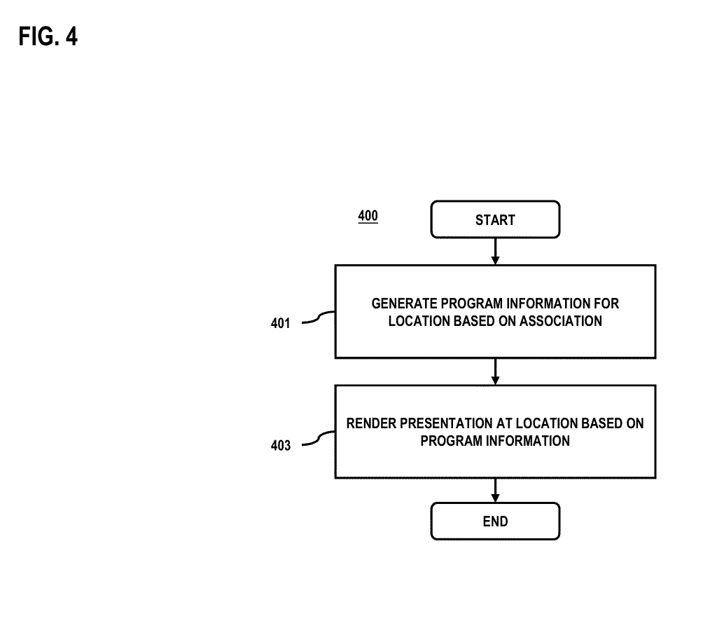

FIG. 4 is a flowchart of a process for presenting program information at a location based on purchase intent information, according to an embodiment. For the purpose of illustration, process 400 is described with respect to FIG. 1. It is noted that the steps of the process 400 may be performed in any suitable order, as well as combined or separated in any suitable manner. In step 401, the intent-based marketing platform 101 may generate program information for the location based on the association. As a result, the program information may be based on the purchase intent information of the user and the location. Subsequently, in step 403, the intent-based marketing platform 101 may render a presentation at the location based on the program information.

As discussed, the program information may relate to a schedule, an advertisement, the user, or a combination thereof. In addition, other factors may be used to generate the program information. For example, the program information may also be based on environmental cues, such as movement detection, faces perceived, identity information transmitted from mobile devices, object recognition, style of clothing, height of detected users, smoking by users, gesture recognition, etc. In this way, different advertisements may be presented at a particular electronic display based on what is sensed in the environment.

In one scenario, for instance, a user may be determined to be within proximity of an electronic billboard (e.g., via GPS data and environmental cues). The user's purchase intent information may indicate that the user “intends” to purchase Item X and that the user's ceiling price for Item X is Price Y. The indication of such purchase intentions may, for instance, be based on the user's previous actions of repeatedly searching for Item X online, browsing information associated with Item X, and bidding for Item X at online auctions (e.g., which may be used to determine the user's ceiling price for Item X). Thus, in response to a determination of the user's purchase intent information, the electronic billboard may be scheduled to present an advertisement for Item X (e.g., as the user is about to pass the billboard) indicating that the user may purchase Item X for the ceiling price along with a scannable coupon that enables the user to purchase Item X for the ceiling price at a store near the billboard. Accordingly, the user will be encouraged to scan the coupon with his/her mobile device and use the coupon at the nearby store.

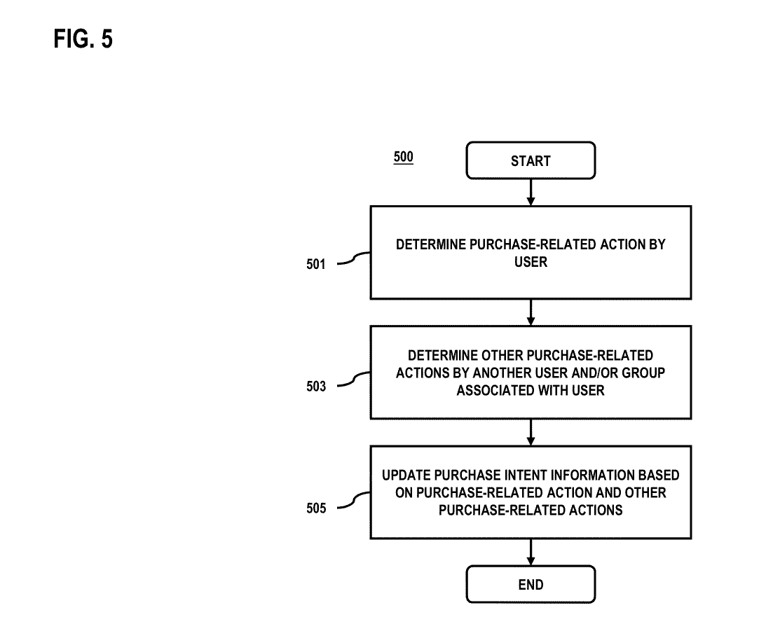

FIG. 5 is a flowchart of a process for updating purchase intent information, according to an embodiment. For the purpose of illustration, process 500 is described with respect to FIG. 1. It is noted that the steps of the process 500 may be performed in any suitable order, as well as combined or separated in any suitable manner. In step 501, the intent-based marketing platform 101 may determine a purchase-related action by the user. As indicated, purchase-related actions may refer to actions that are typically associated with purchasing an item or service, such as scanning a price tag of an item or service, searching for the item or service online, browsing information associated with the item or service, checking out with the item or service in the shopping cart, etc. In one use case, the user may initiate these purchase-related actions using a variety of different services and applications. As such, the purchase-related actions may be stored in the user's account histories associated with those services and applications. Nonetheless, the user may enable sharing of his/her purchase-related actions (e.g., via preferences/settings on those services and applications), allowing the intent-based marketing platform 101 to access such data.

In step 503, the intent-based marketing platform 101 may determine other purchase-related actions of another user, a group, or a combination thereof associated with the user. The intent-based marketing platform 101 may then, at step 505, update the purchase intent information based on the purchase-related action and the other purchase-related actions. In one scenario, for instance, the purchase-related action and the other purchase-related actions may be added to a collaborative filtering-based model that will be used to update the purchase intent information of the user.

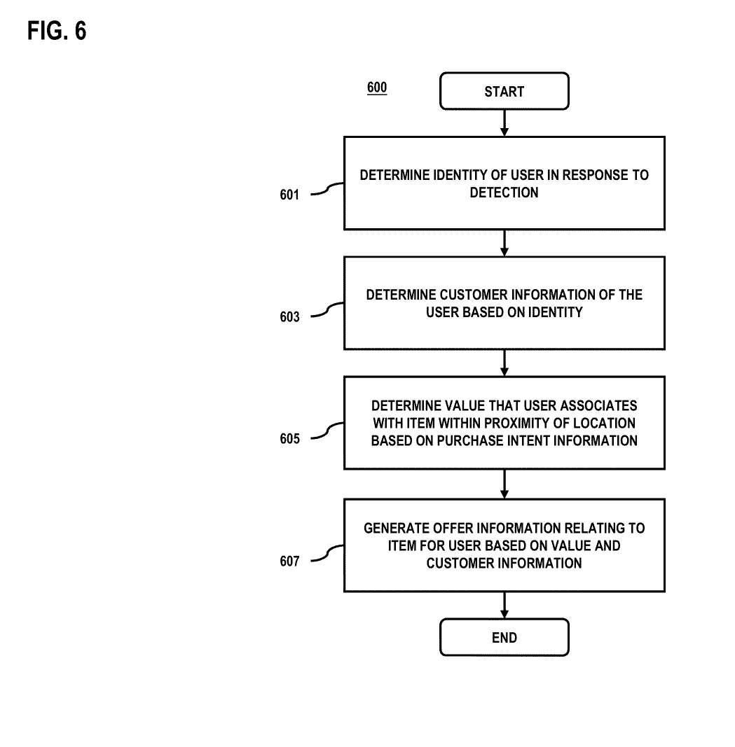

FIG. 6 is a flowchart of a process for generating offers based on purchase intent information and customer information, according to an embodiment. For the purpose of illustration, process 600 is described with respect to FIG. 1. It is noted that the steps of the process 600 may be performed in any suitable order, as well as combined or separated in any suitable manner. In step 601, the intent-based marketing platform 101 may determine an identity of the user in response to the detection. For example, in response to the detection, the intent-based marketing platform 101 may initiate a request to the user's mobile device for identity information. Additionally, or alternatively, the intent-based marketing platform 101 may utilize other techniques for identifying the user, such as facial recognition by one or more devices at the location, analysis of signals emitted from the user's mobile device, etc.

In step 603, the intent-based marketing platform 101 may then utilize the identity to determine customer information of the user (e.g., by accessing the profile database 115). As discussed, in some embodiments, the customer information may include loyalty information, discount information, or a combination thereof associated with the user. In addition, in step 605, the intent-based marketing platform 101 may determine a value that the user associates with an item within the proximity of the location based on the purchase intent information. In one use case, the purchase intent information may include a desired price for the item along with the degree of negotiability of the desired price (e.g., how much more would the users be willing to pay for the item). The user may, for instance, indicate the desired price and the degree of negotiability by manually entering the information into the user's mobile device. On the other hand, the desired price and the degree of negotiability may be automatically determined based on the user's purchase-related actions and/or other similar user's purchase-related actions associated with the purchase intent information.

As such, in step 607, the intent-based marketing platform 101 may generate offer information relating to the item for the user based on the value and the customer information. Thereafter, the offer information may be used to present an offer or an invite to offer to the user at one or more devices at the location (e.g., the user's mobile device, digital signs, etc.). As indicated, in certain embodiments, automatic bargaining and bidding may occur between the user and the nearby stores. The user's desired price and degree of negotiability for the item as well as the user's loyalty information and discount information associated with various stores near the location may, for instance, be utilized to determine the offer information. For example, the desired price and degree of negotiability may be used by services and applications for the user to bargain with the nearby stores for the item. When the services and applications for the user suggests that a store sell an item for a particular price (e.g., based on desired price), each nearby store may look at its loyalty and discount information for the user (e.g., each store may have its own system of determining loyalty or rewards for loyalty) to determine whether to provide the user with an offer or an invite to offer at the particular price, or to provide the user with an offer or an invite to offer at a different price.

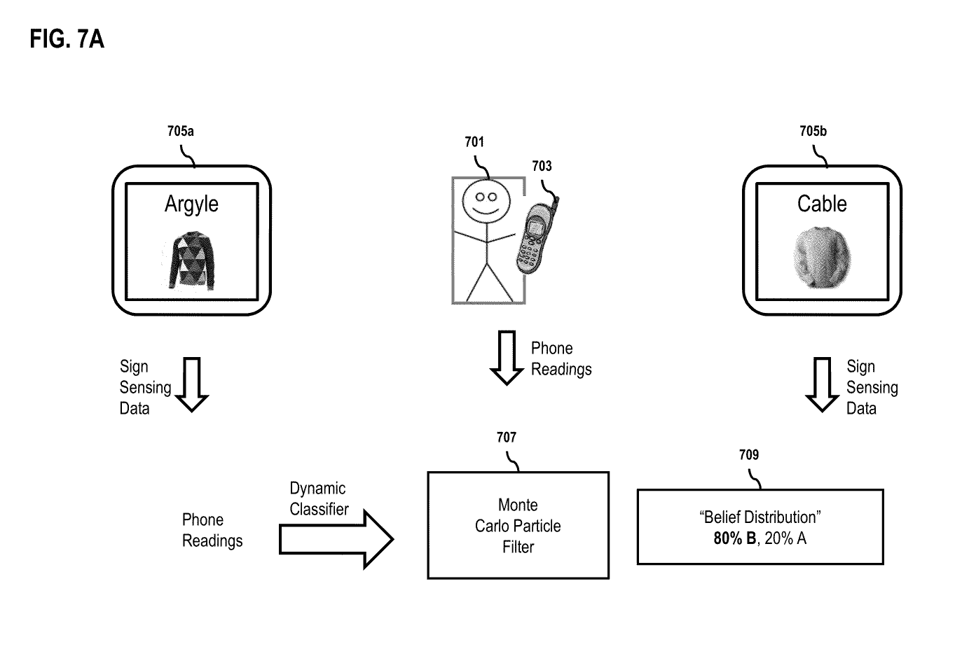

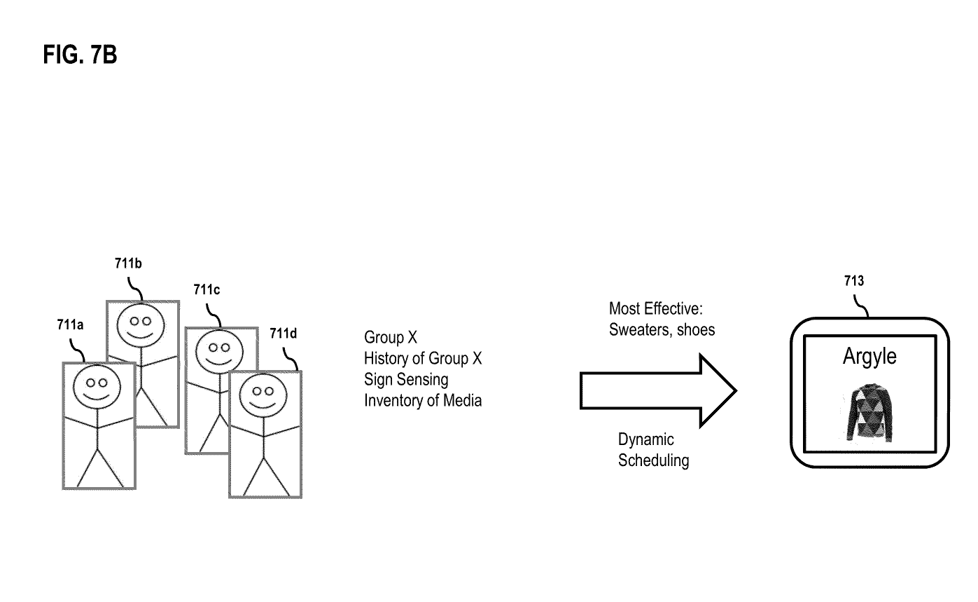

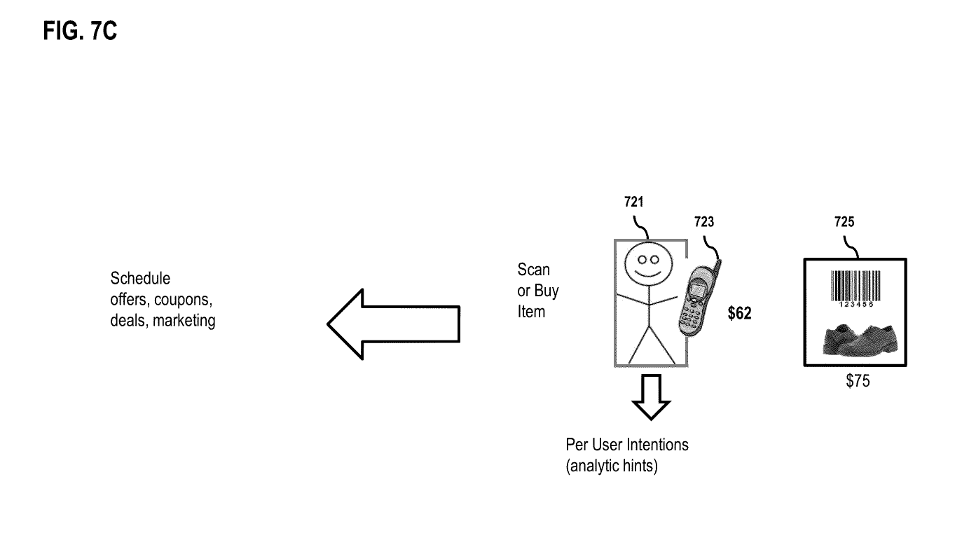

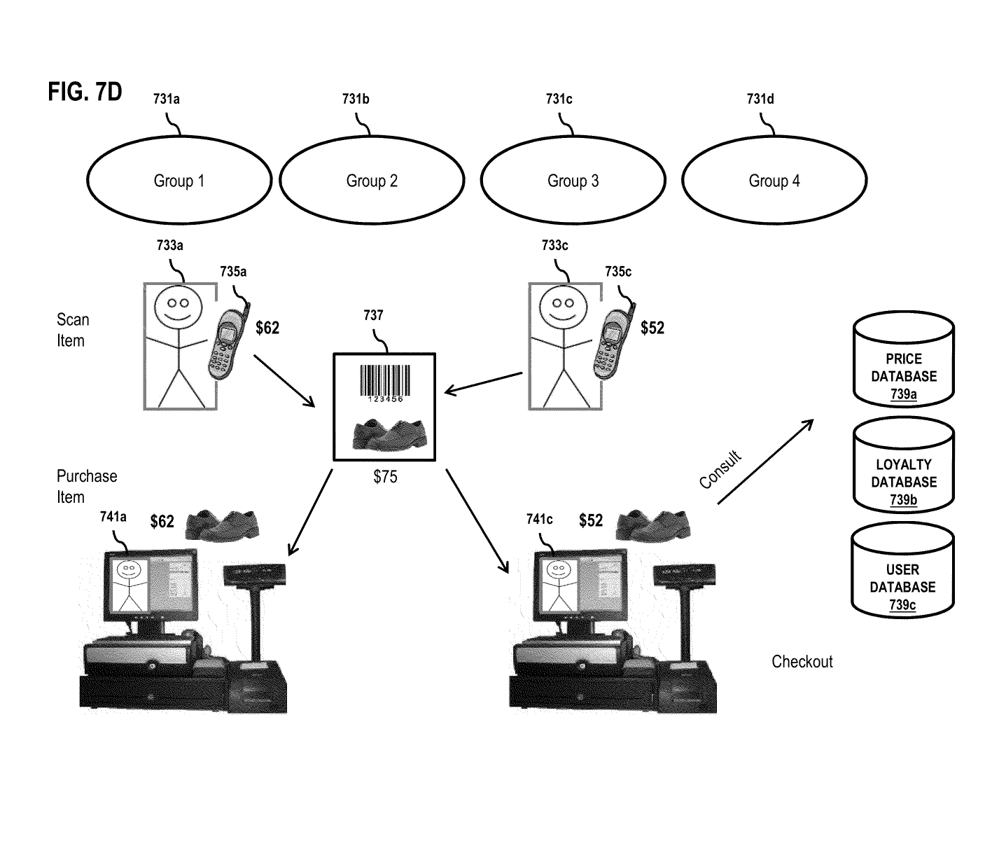

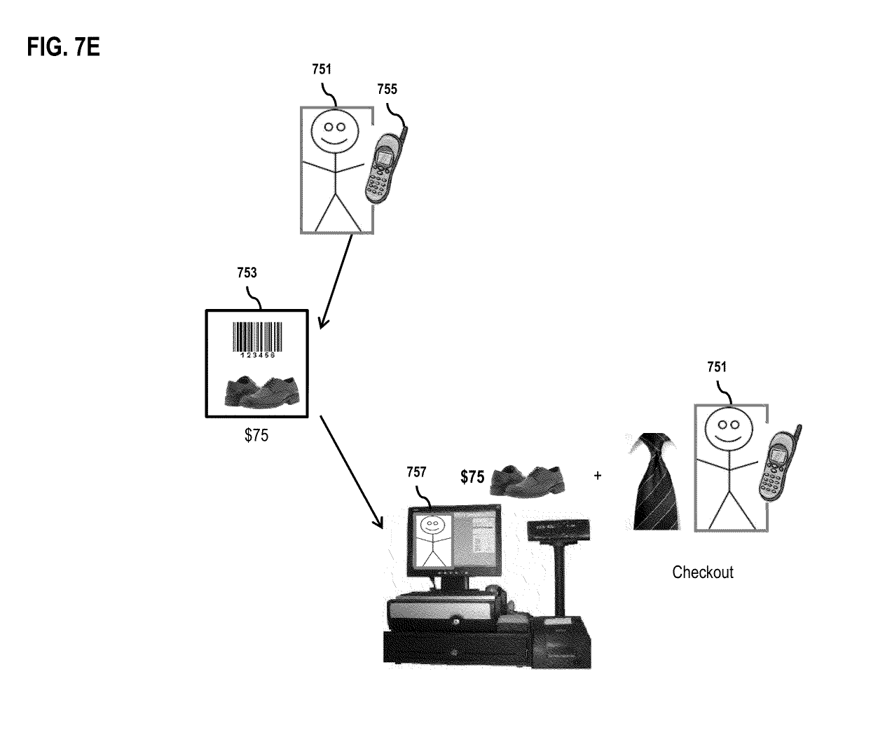

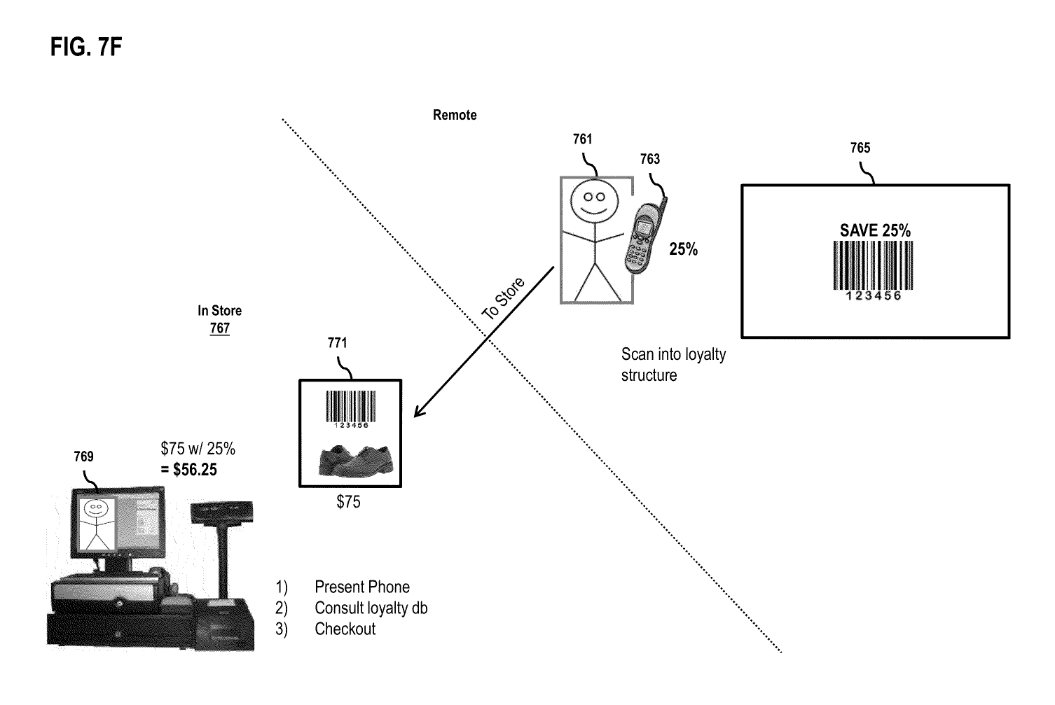

FIGS. 7A-7F are diagrams of scenarios with intent-based proximity marketing, according to various embodiments. For example, FIG. 7A illustrates a user 701 with a mobile phone 703 in an area having various micro-locations with digital signs (e.g., digital signs 705a and 705b). Advanced tracking of the position of the user 701 with respect to the various micro-locations using environmental cues, for instance, provided by the mobile phone 703 (e.g., WiFi, Bluetooth, GPS data, compass data, map information, etc.). In addition, advanced robotics techniques may be used to integrate multiple sources of “belief” of location to determine the user position. In this scenario, for instance, phone readings (e.g., including environmental cues) from mobile phone 703 may be processed by a filter 707 (e.g., a Monte Carlo particle filter) to produce a belief distribution 709 indicating that user 701 (e.g., via mobile phone 703) is much closer to digital sign 705b than digital sign 705a (e.g., “80% B, 20% A”). Thus, program information may be generated for the digital sign 705b (and its micro-location) based on purchase intent information of user 701 to target the content of the digital sign 705b to user 701.

In FIG. 7B, a group of users 711 (e.g., “Group X”) is determined to be within proximity of a micro-location with a digital sign 713 (e.g., based on sign sensing data with environmental cues). In this scenario, history information with purchase-related actions of the group may be processed to determine purchase intent information of the users 711. The purchase intent information along with stored media (e.g., from program database 117) may then be processed to generate the most effective advertisement schedule (e.g., ad-hoc schedule with advertisements for sweaters and/or shoes) for presentation at the digital sign 713 as well as other digital signs at the same micro-location. As noted, the purchase intent information and the advertisement schedule may be generated via a number of techniques, such as collaborative filtering techniques, content-based techniques, etc.

As depicted, in FIG. 7C, data indicating purchase-related actions, such as scanning or buying an item, may be used to generate scheduling information of offers, coupons, deals, and other marketing content for presentation at one or more devices near users associated with the purchase-related actions. In this case, a user 721 with a mobile phone 723 has scanned the price tag 725 of a pair of shoes. This purchase-related action (e.g., scanning the price tag 725) may be processed, for instance, to update the purchase intent information of the user 721 (e.g., stored at profile database 115). As such, although the price tag 725 indicates that the shoes are $75, the user 721 may be presented with an offer to buy the shoes for $62 based on the updated purchase intent information.

FIG. 7D illustrates various loyalty groups 731a-731d, for instance, where a user 733a with a mobile phone 735b is part of the loyalty group 731a and a user 733c with a mobile phone 735c is part of the loyalty group 731c. When user 733a scans a price tag 737 of a pair of shoes with the mobile phone 735a, the purchase intent information of the user 733a may be updated. In addition, the databases 739a-739c may be consulted in determining an offer for user 733a. For example, the price database 739a may be accessed to determine that the list price of the shoes is $75, and the loyalty database 739b and the user database 739c may be accessed to determine that the user 733a is part of the loyalty group 731a and to determine the loyalty information associated with the loyalty group 731a. The loyal information and the purchase intent information may then be utilized to generate the offer for the user 733a (e.g., $62 for the pair of shoes). As depicted, when the user 733a approaches the point-of-sale (POS) 741a to checkout, the identity of the user 733a is determined and the customer information of the user 733a is presented on the POS 741a (e.g., a picture of user 733a with loyalty and discount information along with the sale based on the purchase intent information).

Similarly, when user 733c scans the price tag 737 with the mobile phone 735c, the purchase intent information of the user 733c may be updated, and the databases 739a-739c may be consulted in determining an offer for user 733c. In this case, the loyalty database 739b and the user database 739c may be accessed to determine that the user 733c is part of the loyalty group 731c and to determine the loyalty information associated with the loyalty group 731c. The loyal information and the purchase intent information may then be utilized to generate the offer for the user 733c (e.g., $52 for the pair of shoes). Moreover, when the user 733c approaches the POS 741c to checkout, the identity of the user 733c is determined and the customer information of the user 733c is presented on the POS 741c (e.g., a picture of user 733c with loyalty and discount information along with the sale based on the purchase intent information).

FIG. 7E illustrates dynamic negotiations in a brick and mortar store. It is noted that any model of negotiation can be supported (e.g., bidding, discounts, additional items, future savings, etc.). In this scenario, for instance, user 751 may have expressed interest in purchasing a pair of shoes associated with price tag 753. Additionally, the user 751 may be a high value customer who frequently buys socks and ties from the particular brick and mortar store. As such, both the user interest and the frequent purchases may be indicated in the purchase intent information of the user 751. However, when the user 751 scans the price tag 753 using the mobile phone 755, the user is informed via one or more devices at the location that the store will offer the shoes for $75. Since the offer price is the same as the listed price (e.g., both are $75), the user may walk away from the offer (e.g., detected when the user moves away from the micro-location of the shoes within the store). In response, the store may present a unique offer to the user 751, for instance, to prevent the loss of the sale and to maintain the user 751 as a loyal customer. Specifically, in this case, the offer price of $75 now includes the shoes and a tie. Thus, when the user 751 approaches the POS 757 to checkout, the identity of the user 751 is determined and the customer information of the user 751 is presented on the POS 757 (e.g., a picture of user 751 with loyalty and discount information along with the sale based on the purchase intent information).

FIG. 7F illustrates paperless coupons that may be associated with loyalty information. For example, a user 761 with a mobile phone 763 may be at a remote location having an electronic billboard 765. When the user 761 is detected to be within proximity of the micro-location of the billboard 765 (e.g., via the mobile phone 763), the purchase intent information of the user 761 may be determined and associated with the micro-location. As such, the billboard 765 may present customized content (e.g., customized coupon) based on the purchase intent information when the user 761 is within seeing distance of the content. In this scenario, the customized content is a paperless coupon that the user 761 may scan with the mobile phone 763. The coupon may, for instance, be generated for the user 761 at the micro-location based on the frequent visits to the store 767 and/or purchases of items similar to the item associated with the coupon. When the user 761 scans the coupon, the discount information associated with the coupon may be stored in loyalty information associated with the user 761. Thus, when the user 761 is detected near POS 769 at the store 767 during checkout, and the price tag 771 is scanned at the POS 769, the identity of the user 761 is determined and the customer information of the user 751 is presented on the POS 769 (e.g., a picture of user 761 with loyalty and discount information along with the sale based on the purchase intent information).

The processes described herein for providing intent-based proximity marketing may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 8 is a diagram of a computer system that can be used to implement various embodiments. The computer system 800 includes a bus 801 or other communication mechanism for communicating information and one or more processors (of which one is shown) 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk, flash storage, or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. Additional output mechanisms may include haptics, audio, video, etc. An input device 813, such as a keyboard including alphanumeric and other keys, is coupled to the bus 801 for communicating information and command selections to the processor 803. Another type of user input device is a cursor control 815, such as a mouse, a trackball, touch screen, or cursor direction keys, for communicating direction information and command selections to the processor 803 and for adjusting cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

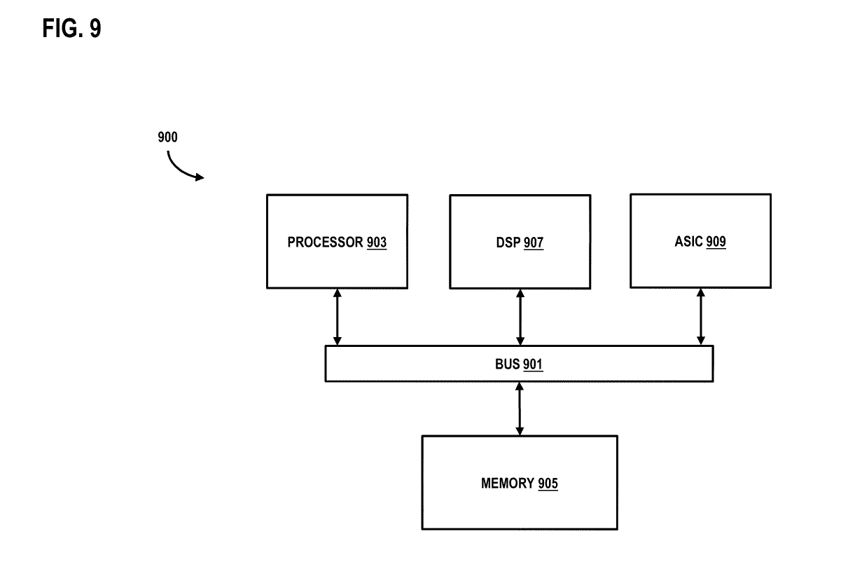

FIG. 9 illustrates a chip set or chip 900 upon which an embodiment of the invention may be implemented. Chip set 900 is programmed to enable intent-based proximity marketing as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of enabling intent-based proximity marketing.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to enable intent-based proximity marketing. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
detecting that a user is within proximity of a location;
determining purchase intent information of the user in response to the detection; and
associating the purchase intent information with the location.

2. A method according to claim 1, further comprising:
generating program information for the location based on the association; and
rendering a presentation at the location based on the program information.

3. A method according to claim 2, wherein the program information relates to a schedule, an advertisement, the user, or a combination thereof.

4. A method according to claim 1, further comprising:
determining a purchase-related action by the user; and
updating the purchase intent information based on the purchase-related action.

5. A method according to claim 4, further comprising:
determining other purchase-related actions of another user, a group, or a combination thereof associated with the user, wherein the purchase intent information is updated based on the other purchase-related actions.

6. A method according to claim 1, further comprising:
determining a value that the user associates with an item within the proximity of the location based on the purchase intent information; and
generating offer information relating to the item for the user based on the value.

7. A method according to claim 1, further comprising:
determining an identity of the user in response to the detection; and
determining customer information of the user based on the identity.

8. A method according to claim 6, wherein the customer information includes loyalty information, discount information, or a combination thereof associated with the user.

9. An apparatus comprising:
at least one processor; and
at least one memory including computer program code for one or more programs,
the at least one memory and the computer program code configured to, with the at least one processor, cause the apparatus to perform at least the following,
detect that a user is within proximity of a location;
determine purchase intent information of the user in response to the detection; and
associate the purchase intent information with the location.

10. An apparatus according to claim 9, wherein the apparatus is further caused to:
generate program information for the location based on the association; and
render a presentation at the location based on the program information.

11. An apparatus according to claim 10, wherein the program information relates to a schedule, an advertisement, the user, or a combination thereof.

12. An apparatus according to claim 9, wherein the apparatus is further caused to:
determine a purchase-related action by the user; and
update the purchase intent information based on the purchase-related action.

13. An apparatus according to claim 12, wherein the apparatus is further caused to:
determine other purchase-related actions of another user, a group, or a combination thereof associated with the user, wherein the purchase intent information is updated based on the other purchase-related actions.

14. An apparatus according to claim 9, wherein the apparatus is further caused to:
determine a value that the user associates with an item within the proximity of the location based on the purchase intent information; and
generate offer information relating to the item for the user based on the value.

15. An apparatus according to claim 9, wherein the apparatus is further caused to:
determine an identity of the user in response to the detection; and
determine customer information of the user based on the identity.

16. An apparatus according to claim 15, wherein the customer information includes loyalty information, discount information, or a combination thereof associated with the user.

17. A system comprising:
one or more processors configured to execute a detection module and a customer relationship management module,
wherein the detection module is configured to detect a user within proximity of a location, and
wherein the customer relationship management module is configured to determine purchase intent information of the user in response to the detection, and associate the purchase intent information with the location.

18. A system according to claim 17, wherein the customer relationship management module is further configured to:
generate program information for the location based on the association; and
render a presentation at the location based on the program information.

19. A system according to claim 17, wherein the customer relationship management module is further configured to:
determine a purchase-related action by the user; and
update the purchase intent information based on the purchase-related action.

20. A system according to claim 17, wherein the customer relationship management module is further configured to:
determine an identity of the user in response to the detection; and
determine customer information of the user based on the identity.

21. A system according to claim 17, wherein the customer relationship management module is further configured to:
determine a value that the user associates with an item within the proximity of the location based on the purchase intent information; and
generate offer information relating to the item for the user based on the value.
